(19) United States
(12) Patent Application Publication
(10) Pub. No.: US 2009/0254486 A1
(43) Pub. Date: Oct. 8, 2009

(54) METHOD FOR VERIFYING VIRTUAL PHYSICAL SPACE REPRESENTING A TRANSACTION CONTEXT IN A VIRTUAL WORLD

(75) Inventors: Gordon D. Hutchison, Eastleigh (GB); Ian Hughes, Southampton (GB)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/098,564

(22) Filed: Apr. 7, 2008

(51) Int. Cl. G06Q 30/00; G06Q 20/00; G06Q 40/00

(52) U.S. Cl. 705/80

(57) ABSTRACT

The ‘rollback room’ is a demarked area of 3D space in the virtual world—it may be branded by its (trusted) provider. Participants who enter the space take a ‘state checkpoint’ of their virtual world state on entering the area and then become participants in a transaction that is taking place in the rollback room. They can buy, sell, or transfer goods with other parties in the room. They may trust these parties to various degrees but can interact with or try out the new ‘goods’ they have received in the rollback room within the confines of the rollback room as normal.

### TECHNICAL FIELD

The present invention generally relates to the field of virtual worlds, and more particularly to a setting for commerce, such as online gaming environments and a method for verifying and/or authenticating virtual space.

### BACKGROUND

Without some level of mediation the virtual world is not unlike the ‘wild west’ where one meets many people (represented, for example, by avatars) of unknown reputation. In a business transaction within a virtual world both parties may be unsure of each other. It would be valuable to develop a third party who is well known and provides some level of protection when doing commerce in this world.

### SUMMARY

Mediation or transaction security, for example, in an online gaming environment or the like, may be provided in a ‘rollback room.’ A rollback room is a demarked area of 3D space in a virtual world which may be branded (operated) by a (trusted) provider. Participants who enter the space take a ‘state checkpoint’ of their virtual world state on entering the area and then become participants in a transaction that is taking place in the rollback room. They can buy, sell, or transfer goods with other parties in the room. They may trust these parties to various degrees but can interact with or try out the new ‘goods’ they have received in the rollback room within the confines of the rollback room as normal.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the invention may be better understood by those skilled in the art by reference to the accompanying figures in which:

FIG. 1 is a flow diagram illustrating a method for trust branding a virtual space in a transaction context in a virtual world.

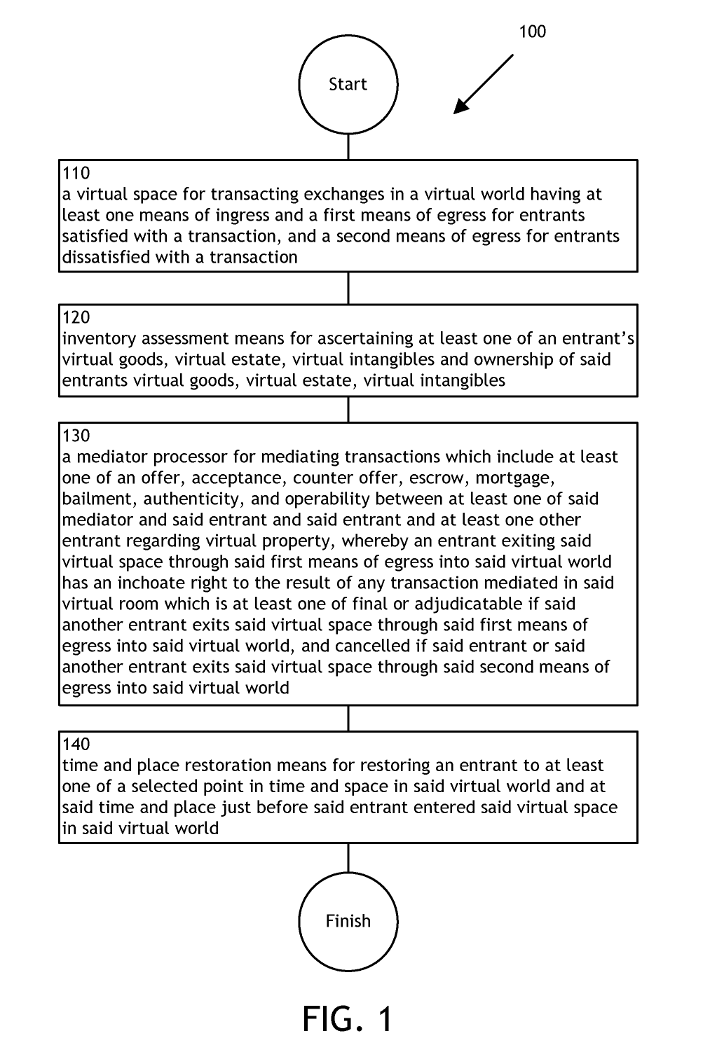

### DETAILED DESCRIPTION

Reference will now be made in detail to the subject matter disclosed, which is illustrated in the accompanying drawing.

In a presently preferred environment 100, the rollback room of the present invention may provide egress via two doors—‘happy’ and ‘unhappy’. If either/any party in any transaction that took place in the rollback room leaves via the ‘unhappy’ door, then the parties that took part in the transaction have their virtual state (elements of it related to the parties that left ‘unhappy’) returned to the state of the checkpoint they had on entering—i.e. new goods ‘vanish’ and any related money transfers are cancelled.

Such rollback rooms could develop trusted brands and be used as ‘shells’ around virtual world shops (where the owner of the “rollback-room” was the same person who is selling the goods) or markets/bazaars (where two people meet and the rollback room takes a certain percentage of all the monies transferred).

In a presently preferred system of the present invention 100, the apparatus of the present invention provides a user-controlled service which can be charged for via a commission, flat fee, or the like. Preferably, the system is operated by a trusted brand with a developed or developing user reliability and trust reputation. There is a constant rolling commit. One party may make the payment while another receives the goods. This model allows for the dynamic construction of complex multi-part and multi-party deals where no-one can be hustled by getting their quid pro quo last.

In operation, the present system provides a method and apparatus for creating and providing a third party mediation space, branded by an entity trusted by both buyers and sellers. Users may be charged a small commission for this feature or be willing to play (engage) more, or be more likely to purchase virtual space or play in a virtual space, or be more satisfied.

An example implementation that could be considered as an add-on to any existing micro-transaction virtual environment, such as SECOND LIFE™, would behave in the following way:

a) Zoned area 110 owned by a trusted source. This is referred to as a parcel of land in SECOND LIFE™ nomenclature.

b) Entry to this parcel (zoned area) is restricted to the two or more parties wishing to make the transaction. This is regular access control and can be created under script control for users to request access. Non-exclusive use of the rollback room is also possible with transaction participants being defined by being involved in the exchange of goods/services.

c) Preferably, this parcel only allows scripts to be from the trusted broker 120 or perhaps initiated by the broker's scripts (or signed/approved by the broker's scripts). The individuals transacting business do not have to run any code and should not have to run any in order to take part in the transaction concept.

d) Preferably, the transaction space also has a transaction coordinator/broker 130 object created in it. This object consists of the majority of the code and controls to deal with compound inventory exchanges.

e) The broker 130 object may be utilized as the conduit to transfer objects and financial transfers between the parties real-time, in batch, in a single, compound, unilateral, bilateral, or multilateral transaction.

f) On coming into range of the broker object and having been allowed into the parcel of land, the avatar accounts 120 of the individuals are recorded by the broker object.

g) Objects are moved between avatars using the broker 130 to own the items and the financial transfers. The broker keeps the record of who owns what in the transfers and the balance owing.

h) On completion of the compound transactions, if both avatars accept and leave via the commit/agree side of the transaction-space/parcel, then the broker distributes the money and objects to each party's long term state.

i) Any disagreement and the broker object returns all quid pro quo (e.g., money and objects) to the original owners 130. It does not need to “take away” money from any party as it has not yet assigned the transfers to the parties involved—they have been granted ‘temporary use’ of the virtual objects and/or their transaction-account has a current delta in it.

Additional enhancements could be off world (real world) recording of the transactions for reporting purposes, and state maintenance should a transaction be halted part way through (before completion), such that the parties (avatars) can return and continue where they left off 140.

In the present invention, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A rollback room in a virtual physical space allowing entering parties to negotiate and consummate transactions and allow a party to unilaterally reverse an unsatisfactory transaction, comprising:
a virtual space for transacting exchanges in a virtual world having at least one means of ingress and a first means of egress for entrants satisfied with a transaction, and a second means of egress for entrants dissatisfied with a transaction;
inventory assessment means for ascertaining at least one of an entrant's virtual goods, virtual estate, virtual intangibles and ownership of said entrants virtual goods, virtual estate, virtual intangibles;
a mediator processor for mediating transactions which include at least one of an offer, acceptance, counter offer, escrow, mortgage, bailment, authenticity, and operability, said transactions between at least one of said mediator and said entrant and said entrant and at least one other entrant regarding virtual property, whereby an entrant exiting said virtual space through said first means of egress into said virtual world has an inchoate right to the result of any transaction mediated in said virtual room which is at least one of final or adjudicatable if said another entrant exits said virtual space through said first means of egress into said virtual world, and cancelled if said entrant or said another entrant exits said virtual space through said second means of egress into said virtual world; and
time and place restoration means for restoring an entrant to at least one of a selected point in time and space in said virtual world and at said time and place just before said entrant entered said virtual space in said virtual world.
